(19) United States
(12) Patent Application Publication
(10) Pub. No.: US 2026/0162407 A1
(43) Pub. Date: Jun. 11, 2026

(54) EXTRACTION OF A USEFUL SIGNAL IN MEDICAL IMAGING

(71) Applicant: Siemens Healthineers AG, Forchheim (DE)

(72) Inventor: Michael Manhart, Fürth (DE)

(21) Appl. No.: 19/409,712

(22) Filed: Dec. 4, 2025

(30) Foreign Application Priority Data
Dec. 5, 2024 (DE) 10 2024 211 637.8

(51) Int. Cl. G06V 10/774; G06V 10/82; G06V 10/98

(52) U.S. Cl. CPC G06V 10/774; G06V 10/82; G06V 10/98; G06V 2201/03

(57) ABSTRACT

A method for training a machine learning algorithm includes selecting a first image detail from an image, wherein the first image detail contains a part of the predefinable structure substantially without artifacts. A second image detail is selected from the image, or the second image detail, which is not part of the image, is provided. The second image detail contains at least one artifact but not a part of the predefinable structure. The method includes superimposing the first image detail and the second image detail to form a first superimposed image detail, and training the machine learning algorithm with the first superimposed image detail as an input variable, and the first image detail second image detail as the respective output variable.

This application claims the benefit of German Patent Application No. DE 10 2024 211 637.8, filed on Dec. 5, 2024, which is hereby incorporated by reference in its entirety.

### BACKGROUND

The present embodiments relate to a method for training a machine learning algorithm for extracting a predefinable structure from an image, a method for extracting a predefinable structure from an input image using a machine learning algorithm, and a corresponding apparatus and a computer program.

Movement artifacts in DSA imaging frequently impair the diagnostic image quality. Registering masks for filling images via conventional or learning-based algorithms may reduce subtraction artifacts. With difficult motion patterns (e.g., non-rigid motion, motion in a plurality of slices, motion along the detector normal), the compensation of 3D motion patterns via 2D registration techniques does not lead to appropriate results, however. For example, peristaltic movements are a frequent problem in time-critical emergency procedures.

With periodic motion such as breathing, capturing a series of mask images over a plurality of breathing phases and the subsequent automatic comparison with the fill images is possible.

However, this approach frequently fails with non-periodic motion. Su, Ruisheng, et al., “AngioMoCo: Learning-Based Motion Correction in Cerebral Digital Subtraction Angiography,” International Conference on Medical Image Computing and Computer-Assisted Intervention; Cham: Springer Nature Switzerland, 2023 proposed a method named “AngioMoCo” that integrates contrast extraction and motion correction via a deformation field using learning-based models. It is shown that when estimating the deformation field, distortions are avoided by an inflow of contrast, and a real-time estimation of complex deformation fields is possible with head DSA. However, the exacting motion patterns in the lungs or abdomen are not adequately compensated since they are still based on a 2D registration.

Patent application US20230263493 A1 uses Deep Learning to predict subtraction images directly from fill images in that spatial and temporal items of information are used for identifying vessel densities. However, the generation of vascular images by neural networks instead of a simple subtraction poses the risk of hallucinations or changes in the contrast and the vessels, and this leads to insufficient interpretability. The proposed approach is trained by the application of estimated 2D motion patterns to motion-free clinical DSA series. This works well with affine motion patterns, as prevail with head DSA, but is again of limited use with the exacting motion patterns that occur in the case of lung and abdominal imaging.

To summarize, the existing approaches work either for periodic or rigid/affine motions. None of the approaches currently available is capable of compensating complex motion patterns such as peristaltic movements. Further, the risk of hallucinations or changes in the vascular details, which are produced with learning-based approaches, in which the vascular images are calculated directly from the fill images, has not yet been reduced.

Further, a network for the volumetric segmentation that is learned from sparsely annotated volumetric images is presented in Çiçek, Özgün et al., “3D U-Net: Learning Dense Volumetric Segmentation from Sparse Annotation,” eprint arXiv: 1606.06650; Pub date: June 2016 DOI: 10.48550/arXiv.1606.06650. In a semi-automatic structure, the user annotates some slices of the volume that is to be segmented. The network learns from these sparse annotations and supplies a dense 3D segmentation. In an alternative fully automatic structure, it is assumed that a representative, sparsely annotated training dataset exists. Trained with this dataset, the network densely segments new volumetric images. The proposed network expands the previous u-net architecture in that it replaces all 2D operations with its 3D counterparts.

The two following articles describe the representation of model uncertainties in neural networks: Abdar, Moloud, et al., “A review of uncertainty quantification in deep learning: Techniques, applications and challenges,” Information fusion 76 (2021): 243-297 and Gal, Yarin and Zoubin, Ghahramani., “Dropout as a bayesian approximation: Representing model uncertainty in deep learning,” international conference on machine learning. PMLR, 2016.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, artifacts that are caused, for example, by complex motions may be more reliably compensated.

In one embodiment, a method for training a machine learning algorithm for extracting a predefinable structure from an image is accordingly provided. The algorithm may be based on different mathematical models, such as artificial neural networks, linear regression, support vector machines, and the like. The algorithm is trained and consequently optimized for its task of extracting a predefinable structure. The predefinable structure (e.g., useful signal) is to be extracted from a digital image. The predefinable structure may be a mapping of a vessel, organ, implant, catheter, etc. A typical application may be, for example, the extraction of a vascular tree in digital subtraction angiography (DAS).

In one act of the method of the present embodiments, a first image detail is selected from the image, where the first image detail contains a part of the predefinable structure substantially without artifacts. The digital image may be divided into image details or have such image details. The image details are also frequently referred to as “patches.” When selecting the details, an attempt is made to semantically separate or identify image contents. The first image detail contains the predefinable or predefined structure (e.g., a vessel or a vascular tree; visual representations of the structure). Further, the first image detail is selected such that the first image detail contains as few artifacts as possible. Such artifacts may be produced due to motion of the mapped object, due to noise, or due to other interference. The first image detail may contain as few artifacts as possible but optimally clearly at least a part of the predefinable structure.

In a further act, a second image detail is selected from the image, or the second image detail, which is not part of the image, is provided. The second image detail contains at least one artifact, but not part of the predefinable structure. In contrast to the first image detail, the second image detail thus contains as many or clear artifacts as possible and as little as possible of the predefinable or predefined structure. In one variant of this method act, the second image detail, like the first image detail, is selected from the image. This provides that the image is divided into a plurality of image details and the respective image details are gathered or identified. In an alternative variant, the second image detail is provided in a different way (e.g., by artificial generation, reading from a database, or in a similar manner). For example, an image detail may be generated with artificial noise. Similarly, image details may be generated with artificial motion patterns. The second image detail does not then originate from the image from which the first image detail was selected

In a further act, the first image detail and the second image detail are superimposed to form a first superimposed image detail. This provides that the two image details are artificially overlaid. For example, superimposition takes place via addition. However, the superimposition may also take place via more complex overlaying strategies.

In a subsequent act, the actual training of the algorithm takes place with the first superimposed image detail as the input variable, and the first image detail and the second image detail as the respective output variable. The actual task of the algorithm is to generate an output variable from an input variable. In the present case, the input variables and output variables are respective image details. The input variable is the first superimposed image detail superimposed from the first image detail and the second image detail. This first superimposed image detail contains, for example, a vessel section superimposed with one or more motion artifacts. The output variable is composed of two image details (e.g., the first image detail and the second image detail). The output variable therefore contains, separated, the predefinable structure underlying the superimposed image, separated from the artifact. The algorithm is therefore trained to separate the superimposed image detail into the underlying image details. It is consequently possible that the predefinable structure is extracted from the superimposed image. Specifically, for example, vessels without motion artifacts may thus be visually represented.

In one example embodiment, it is provided that either at least one third image detail of the same first type as the first image detail is selected and is superimposed with the second image detail to form a second superimposed image detail, or at least one third image detail of the same second type as the second image detail is selected and is superimposed with the first image detail to form the second superimposed image detail. The second superimposed image detail is used as a further input variable for training the algorithm, and the third image detail is used as a further output variable for training the algorithm. In one variant, a third image detail of the same type as the first image detail is therefore selected. For example, both image details contain details of vessels. This provides that the two image details are of the vessel type. The third image detail, like the first image detail (e.g., both vascular image details), is superimposed with the second image detail containing artifacts. This superimposition of the third image detail and the second image detail produces the second superimposed image detail. A further training dataset is thus produced (e.g., the second superimposed image detail and the (second as well as) third image detail). Alternatively, the third image detail is of the same type as the second image detail. This provides that the third image detail contains artifacts, but not the predefinable structure (e.g., therefore, no vessel sections). However, the third image detail differs from the second image detail and contains, for example, other artifacts. The third image detail is superimposed, for example, with the first image detail to form the second superimposed image detail. The new training dataset is thereby similarly produced from the second superimposed image detail and (e.g., the first as well as) the third image detail. New superimposed images may thus be generated with each newly selected image detail via alternate superimposition.

In a further example embodiment, it is provided that the image is divided into a large number of image details of the first type and a large number of image details of the second type, the image details of the first type respectively are superimposed with an image detail of the second type, whereby one superimposed image detail respectively is produced, and all superimposed image details of the first type and the second type are used as output variables and all superimposed image details are used as input variables when training the algorithm. In other words, the original image is broken down or divided into a large number of image details. This division may be gap-free or have gaps. Gap-free provides that each part of the image pertains to an image detail. An image may be divided, for example, into square or rectangular image details, and each image detail may be assigned to a specific type (e.g., image detail (predominantly) with artifact or image detail (predominantly) with vessel).

According to a further example embodiment, the image is also divided into a large number of image details of a third type, where these image details contain a part of the predefinable structure as well as artifacts, and the image details of the third type are also used as input variables when training the algorithm. This provides that virtually natural superimposed image details are selected from the image and used for the training. The original image is thus divided into at least three types of image details (e.g., into image details with vessels (vessel type), image details with artifacts (artifact type), and image details with vessels as well as with artifacts (mixed type)). The algorithm may thus also be trained based on mixed image details, and this increases the reliability thereof.

In a further example embodiment, it is provided that superimposing the respective image details is based on an addition of the image details involved. As already mentioned above, the superimposition may take place via simple addition of the image details. If necessary, after the addition, additional processing takes place during the course of superimposition.

According to a further example embodiment, providing the second image detail includes generation via a generative artificial intelligence (AI) unit. In other words, an appropriate generative algorithm generates the second image detail as an image detail that has at least one artifact. The generative AI unit may thus generate a plurality of input data for training the algorithm.

In a further example embodiment, the second image detail is provided by a phantom scan. For example, an image recording or image series is thus obtained from a phantom with the aid of an imaging modality. The phantom is an artificial object, such as a cylinder filled with water. Consequently, image details that originate from phantom recordings may also be used for training the algorithm.

In an example embodiment, the algorithm includes an artificial neural network. For example, a network with a U-structure is used. If necessary, a network that is configured for 3D operations is used. Spatial structures may also be extracted thereby and are separated, for example, from motion artifacts.

In a further example embodiment, it is provided that the image is part of a time series, and thus, each image detail is assigned to the time series. This provides that each image detail mentioned above may be regarded as an image detail series. Image series may thereby be used for all input and output variables of the algorithm. The consequence of this is that the algorithm may be trained with time as an additional dimension. Temporal features, in addition to local features, may thus be used for the algorithm.

In one example embodiment, the artifacts result from a motion of the object represented in the time series. The motions therefore cause artifacts (e.g., during image generation or image processing) that obscure the actual object structure. The more or less complex motions of the object may have an effect not only on individual images, but, owing to the temporal connections, an entire image series or time series. However, even time series distorted in this way may be corrected with the aid of the algorithm, or the corresponding structures may be extracted in the time series.

According to a further example embodiment, it is provided that the image and all image details contain spectral items of information that are taken into account when training the algorithm. For example, the original image is obtained with a Dual Layer Detector. As a result, spectral items of information may also be obtained with the image recording. These spectral items of information may be used as additional input variables or items of input information for the algorithm. As a result, structures may be extracted, or artifacts may be compensated with an even higher quality.

In a further example embodiment, the image is obtained by digital subtraction angiography. Specifically, appropriate image series (e.g., time series) may be obtained with digital subtraction angiography. However, the respective image may also be created without subtraction of a mask. The appropriately trained algorithm may sufficiently clearly extract vessels, for example, even without a mask image. The process time may accordingly be reduced by dispensing with a mask image.

The algorithm that has been trained as described above may be applied for extracting the predefinable structure. This may be implemented in a method for extracting a predefinable structure from an input image using a machine learning algorithm that is trained according to the above method. For example, as already indicated, it is possible to separate vessels, organs, implants, catheters, etc. from artifacts in an image or an image series.

In a specific example embodiment, it is provided that an output image with the extracted structure is generated by the algorithm from the image or input image, and the input image is overlaid at least with parts of the output image. When applied to an input image, the algorithm supplies a structure freed from artifacts, but for the user, it may be expedient to receive this extracted structure overlaid with the input image. In certain circumstances, it is, for example, not sufficient if only the extracted structure is represented and possible additional items of information from the input image are not presented. For improved orientation, input image and output image may therefore be overlaid. In a specific example embodiment, the extracted structure is highlighted in color in the output image. This provides that when input image and output image are overlaid, it is easier to identify the structure marked in color in the input image surroundings. If necessary, a specific color coding may also take place. For example, those parts of a structure that were identified by the algorithm with a high level of certainty as the sought structure may be represented with an intensive color. Other parts of the structure that were identified with less certainty may be represented in a paler color.

In a further example embodiment, it may be provided that the extracted structure is identified in the output image with a measure of certainty that indicates with what certainty the structure extracted from the algorithm corresponds to the predefinable structure of the input image. For example, this measure of certainty may be explicitly given in number form. The measure of certainty may refer, for example, to corresponding probabilities when using a neural network. For example, the measure of certainty may be obtained by Bayesian approximation (cf., Abdar, Moloud, et al., and Gal, Yarin et al.).

As another example, an apparatus with a data processing unit that is configured to execute an above-described method. The data processing unit may have one or more processors as well as one or more memory units. For example, the machine learning algorithm is implemented on the data processing unit.

Further, the above-mentioned object is achieved by a computer program or a computer program product (e.g., including a non-transitory computer-readable storage medium) that includes commands that, when the program is executed by the apparatus, cause the apparatus to execute the above-mentioned method.

### BRIEF DESCRIPTION OF THE DRAWINGS

FIG. 1 shows a schematic representation of an example embodiment of an imaging modality;

FIG. 2 shows a schematic view for generating training data;

FIG. 3 shows the marking of image details;

FIG. 4 shows the application of a trained algorithm; and

FIG. 5 shows a schematic method sequence as a block diagram.

### DETAILED DESCRIPTION

Example embodiments are illustrated in more detail below.

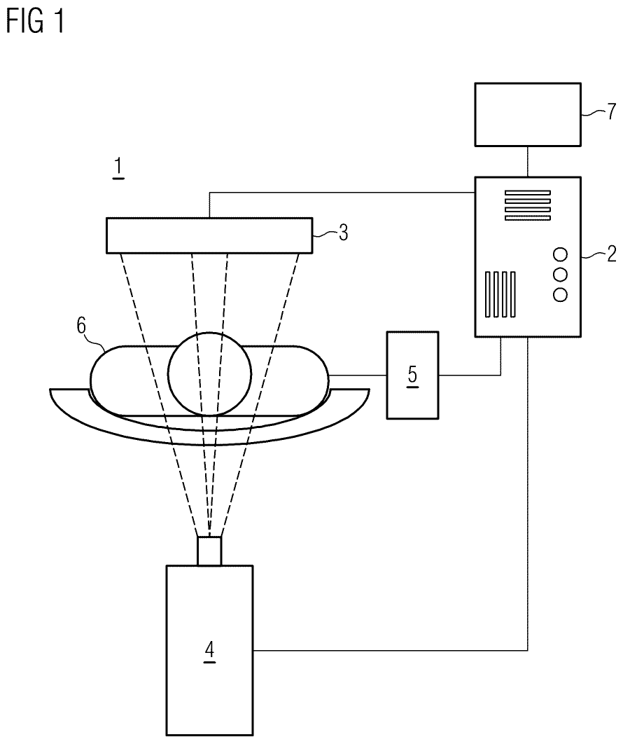

FIG. 1 schematically represents an example embodiment of an imaging system 1 that is representative of other imaging modalities. The imaging system 1 has at least one computing facility or data processing unit 2, a contrast agent injector 5, and an imaging modality that, in the present example, is configured, without limiting the generality, as an X-ray-based imaging modality (e.g., for perfusion imaging, CTA, or DSA) including an X-ray source 4 and an X-ray detector 3.

The at least one data processing unit 2 (e.g., including one or more processors) is configured to carry out a method of the present embodiments for visual extraction of a structure (e.g., segmentation of a vascular system) of a patient 6 with freedom from artifacts. A schematic flowchart of such a method is represented in FIG. 5 and described below. As a result of the method, the at least one data processing unit 2 stores a dataset of an extracted structure and then generates, based on the separated or extracted structure, at least one control signal for actuating a display facility 7. The display facility then represents, for example, the vascular system separated from motion artifacts.

Using the imaging modality, it is possible to carry out a corresponding imaging method while utilizing the effects of the contrast agent. However, parts of the imaging method may also be carried out before the injection of contrast agent (e.g., in the subtraction method).

For example, for vascular imaging in the case of difficult motion patterns, such as peristaltic motion, a new learning-based approach with a dedicated learning and visualization strategy is provided. No motion-free reference data may exist for these cases. Further, the virtual deformation of 2D images in the case of non-rigid, multi-layered motion does not lead to realistic motion-distorted images. Therefore, no training data with pairs of motion-distorted and motion-free images may be directly available for supervised training.

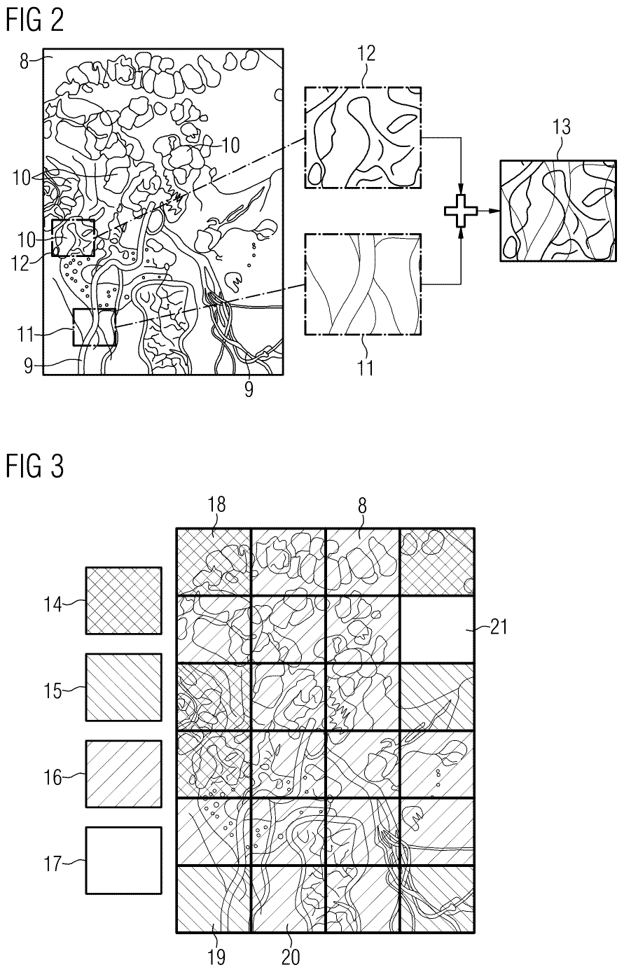

FIG. 2 shows an example of the proposed concept for generating suitable training data for complex motions. The image 8 represented by way of example in FIG. 2 shows vessels 9 and motion artifacts 10. The aim is to be able to train a machine learning algorithm (e.g., artificial neural network), such that the machine learning algorithm may extract a predefinable structure (e.g., vessels 9) from an image covered by artifacts. Appropriate training sets are to be provided for this training. For this purpose, in the example of FIG. 2, a first image detail 11 is selected from the image 8. The first image detail 11 contains a vessel 9 as the predefinable structure. If necessary, the training may also be directed towards other predefinable structures, such as organs, implants, catheters, etc.

Further, a second image detail 12 is selected from the image 8. The second image detail 12 contains an artifact 10 but no vessel 9. Alternatively, a second image detail 12 of this kind may also be provided in another way. Artifact image details may originate, for example, from phantom scans or from other scanned images. As a further alternative, artifact image details may also be artificially generated. For example, noisy images or image details may also be generated by AI (e.g., artificial intelligence).

The first image detail contains a part of a vascular system substantially without artifacts. This provides that the artifacts in the first image detail play, at most, a subordinate role or are not even present. By contrast, the second image detail 12 contains at least one artifact 10, but no part of the vascular system. The expression “no part” provides that the predefinable structure in the second image detail plays no role in practice. Thus, the portion of the predefinable structure may be, for example, extremely low in terms of area or be practically undiscernible to the human eye or not be present at all.

A superimposed image detail 13 is generated from the first image detail 11 and the second image detail 12. This generation may take place by way of a pure addition of the two image details 11 and 12, but also by way of a different superimposition. The superimposed image detail 13 represented by way of example in FIG. 2 was produced by a simple additive overlaying of the two image details 11 and 12.

Insertion D. FIG. 3 shows the division of the image 8 into types of image details. Here, the entire image 8 is divided into image details. However, it is not necessary for the entire image to be divided into image details. Instead, it is also possible for only some of the image 8 to be divided into image details, so corresponding gaps remain.

In the example of FIG. 3, the image 8 is divided into image details of the artifact type 14, vessel type 15, mixed type 16 and empty type 17. For example, the image detail 18 of image 8 top left is of the artifact type 14. The image detail 19 bottom left is of the vessel type 15. The image detail 20 to the right of this is of the mixed type 16. The image detail 21 (second from the top right) is of the empty type 17 since it shows neither artifacts nor vessels. For training the algorithm, corresponding to the example of FIG. 2, one image detail respectively of the artifact type 14 may be superimposed with an image detail of the vessel type 15, whereby a corresponding superimposed image detail is produced. This kind of superimposing of two image details of different types together with the corresponding superimposed image detail represent a training dataset for the algorithm.

In accordance with the approach of the present embodiments, existing image series (e.g., DSA series) may also be divided into 2D+t-patches (e.g., time series of two-dimensional image details). In the same way (if necessary, exclusively), these patches (e.g., image details) contain, for example, solely regions with pure vessel filling or with pure background motion artifacts. If necessary, the patches also contain (e.g., solely) mixed vessel/motion regions and/or empty regions (e.g., neither vessels nor motion artifacts, only noise).

The combination of patches 11 with pure vessel filling and patches 12 with pure background motion creates artificial realistically mixed patches 13 with corresponding “ground truth separation” (e.g., from such data, it is known what result it to be delivered). The superimposed images, as mentioned, may be created via simple addition based on logarithmic processing of the DSA data. However, generative AI approaches may also be used for an even more realistic combination, which includes noise, scatter, or beam hardening effects.

In addition, as also already indicated above, motion-free vascular fill images from datasets of other organs with little motion or background motion images that were created from phantom scans (e.g., air bubbles in water) may be used as an input for creating artificial superimposed image details 13.

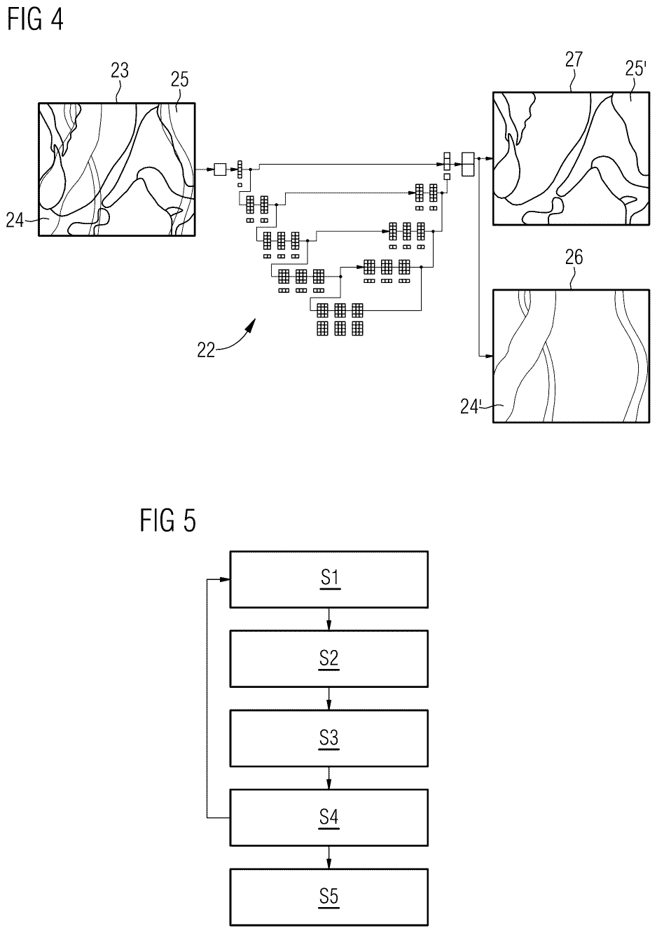

FIG. 4 shows an example of the possible structure of an algorithm 22 (e.g., an artificial neural network (3D U-net)) for reproducing the vascular structures that are overlaid by background motions. An image that represents an input image 23 for the algorithm 22 is obtained by an imaging modality (e.g., a DSA system). A vessel 24 as a predefinable structure overlaid with motion artifacts 25 is represented in the input image 23. The algorithm 22 separates the input image 23 into an output image 26 with an extracted vessel 24′, as well as optionally a further output image 27 with the motion artifacts 25′.

In the case of time or images series, the algorithm 22 or the network 2D+t separates image details with the aid of temporal and or spatial image features into motion background and vascular images.

FIG. 5 shows as a block diagram the schematic sequence of an example embodiment of a method for training an algorithm as well as for subsequent application for extracting a predefinable structure. In act S1, a first image detail is selected from an image, with the first image detail containing a part of the predefinable structure (e.g., vessel) substantially without artifacts. For example, as a first image detail, a vascular image detail that has as few artifacts as possible is selected from the image.

In a further act S2, a second image detail is selected from the image, with the second image detail containing at least one artifact, but no part of the predefinable structure. For example, an artifact image detail that has an artifact, but as far as possible no part, for example, of a vessel, is selected from the image. Alternatively, the second image detail may also be selected or provided from a different image or be artificially generated.

In a further act S3, the first image detail and the second image detail are superimposed to form a superimposed image detail. Thus, for example, the image detail with the vascular structure is artificially overlaid with motion artifacts.

In a subsequent act S4, the algorithm is trained with the first superimposed image detail as the input variable, and the first image detail and the second image detail as the respective output variable. The algorithm is therefore trained with a training dataset that consists at the input side of the superimposed image detail and at the output side of the vascular image detail and the artifact image detail. The algorithm may also be trained with further corresponding training datasets.

According to a further act S5, the algorithm may be applied. An input image may be input into the algorithm, and the algorithm generates one or more output images from the input image. In the output image, the vascular system, for example, is extracted from the input image overlaid with motion artifacts.

To minimize the risk of hallucinations or changes in the vascular details via the neural network, the extracted vascular structures may be displayed as an overlay on the original (e.g., subtracted) images. The overlay may be color coded in order to visualize uncertainties in the vessel prediction. Specific techniques may be used in a neural network to represent the model uncertainty (e.g., the use of “dropout” as a Bayesian approximation (cf., Abdar, Moloud, et al. and Gal, Yarin et al.)). This provides that the original, subtracted image is always visible to the user and no items of information are lost. The color coding helps in assessing the reliability of the items of additional information provided by the overlay.

Alternatively, the algorithm may also be trained and applied for/to non-subtracted data (e.g., maskless DSA). In addition, generative AI networks may be used for creating large quantities of training data based on initial training data. Further, a dual layer detector may be used for the utilization of spectral items of information by the algorithm.

In one embodiment, a new approach to generating training data and to visualizing the separation of motion signal and contrast signal may thus be provided. This makes it possible to reduce motion artifacts in extremely difficult cases of non-rigid multi-planar motion (e.g., in DSA), while the risk of hallucinations or changes in the vascular details may be decreased via a color-coded overlay based on uncertainty.

Independent of the grammatical term usage, individuals with male, female, or other gender identities are included within the term.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for training a machine learning algorithm for extracting a predefinable structure from an image, the method comprising:
selecting a first image detail from the image, wherein the first image detail contains a part of the predefinable structure substantially without artifacts;
selecting a second image detail from the image or providing the second image detail, which is not part of the image, wherein the second image detail contains at least one artifact but not a part of the predefinable structure;
superimposing the first image detail and the second image detail, such that a first superimposed image detail is formed; and
training the machine learning algorithm with the first superimposed image detail as an input variable, and the first image detail and the second image detail as respective output variables.

2. The method of claim 1, wherein at least one third image detail of a same first type as the first image detail is selected and superimposed with the second image detail, such that a second superimposed image detail is formed, or at least one third image detail of a same second type as the second image detail is selected and superimposed with the first image detail, such that the second superimposed image detail is formed, and
wherein the second superimposed image detail is used as a further input variable when training the machine learning algorithm, and the third image detail is used as a further output variable when training the machine learning algorithm.

3. The method of claim 2, wherein the image is divided into a number of image details of the first type and into a number of image details of the second type, the image details of the first type are superimposed with an image detail of the second type, respectively, one superimposed image detail respectively being produced, all image details of the first type and the second type are used as output variables, and all superimposed image details are used as input variables when training the machine learning algorithm.

4. The method of claim 3, wherein the image is also divided into a number of image details of a third type, and
wherein the number image details of the third type contain a part of the predefinable structure and artifacts, and the number of image details of the third type are also used as input variables when training the machine learning algorithm.

5. The method of claim 1, wherein the superimposing is based on an addition of the first image detail and the second image detail.

6. The method of claim 1, wherein selecting the second image detail from the image or providing the second image detail comprises generating the second image detail using a generative AI unit.

7. The method of claim 1, wherein the second image detail is provided by a phantom scan.

8. The method of claim 1, wherein the machine learning algorithm comprises a neural network.

9. The method of claim 1, wherein the image is part of a time series, and each image detail of the first image detail and the second image detail is assigned to the time series.

10. The method of claim 9, wherein the artifacts result from a motion of an object represented in the time series.

11. The method of claim 1, wherein the image and all image details of the first image detail and the second image detail contain spectral items of information that are taken into account when training the machine learning algorithm.

12. The method of claim 1, wherein the image is obtained by digital subtraction angiography.

13. A method for extracting a predefinable structure from an input image using a machine learning algorithm, the method comprising:
training the machine learning algorithm, the training comprising:
selecting a first image detail from an image, wherein the first image detail contains a part of the predefinable structure substantially without artifacts;
selecting a second image detail from the image or providing the second image detail, which is not part of the image, wherein the second image detail contains at least one artifact but not a part of the predefinable structure;
superimposing the first image detail and the second image detail, such that a first superimposed image detail is formed; and
training the machine learning algorithm with the first superimposed image detail as an input variable, and the first image detail and the second image detail as respective output variables; and
extracting the predefinable structure from the input image using the trained machine learning algorithm.

14. The method of claim 13, further comprising:
generating, by the machine learning algorithm, an output image with the extracted structure from the input image; and
overlaying the input image at least with parts of the output image.

15. The method of claim 14, wherein the extracted structure is highlighted in color in the output image.

16. The method of claim 13, wherein the extracted structure is identified in the output image with a measure of certainty that indicates with what certainty the structure extracted by the machine learning algorithm corresponds to the predefinable structure of the input image.

17. An apparatus comprising:
a processor configured to train a machine learning algorithm for extracting a predefinable structure from an image, the processor being configured to train the machine learning algorithm comprising the processor being configured to:
select a first image detail from the image, wherein the first image detail contains a part of the predefinable structure substantially without artifacts;
select a second image detail from the image or providing the second image detail, which is not part of the image, wherein the second image detail contains at least one artifact but not a part of the predefinable structure;
superimpose the first image detail and the second image detail, such that a first superimposed image detail is formed; and
train the machine learning algorithm with the first superimposed image detail as an input variable, and the first image detail and the second image detail as respective output variables.
